(19) United States
(12) Patent Application Publication
(10) Pub. No.: US 2023/0344732 A1
(43) Pub. Date: Oct. 26, 2023

(54) INTELLIGENT WAN SWITCHING WITH A ROUTING DEVICE

(71) Applicant: INSEEGO CORP., San Diego, CA (US)

(72) Inventors: LEIF JORDAN STEIGLEDER, San Diego, CA (US); MIKKO JAAKKOLA, San Diego, CA (US); SANGRAM TIDKE, San Diego, CA (US)

(21) Appl. No.: 17/725,768

(22) Filed: Apr. 21, 2022

(51) Int. Cl. H04L 43/0811; H04L 43/0882; H04L 45/00; H04L 45/42

(52) U.S. Cl. CPC H04L 43/0811; H04L 43/0882; H04L 45/22; H04L 45/42

(57) ABSTRACT

Embodiments disclosed may include a system and/or method for providing an intelligent WAN switching for a device such as a hotspot. Embodiments of the method may include receiving various user inputs. For example, the process may receive one or more user inputs to select one or more network connection parameters, which determine the operating characteristics of a particular network, receive one or more inputs to set a priority level for each of the network connection parameters, and receive one or more inputs to set a threshold level for each of the network connection parameters. Embodiments may be implemented to further monitor a plurality of network connection parameters, as associated with a primary network connection. If a connection parameter associated with the primary network connection crosses an acceptable threshold range and/or a priority level, as described above, the hotspot can switch from a primary network connection to a secondary network connection.

### TECHNICAL FIELD

The present disclosure relates generally to cellular routers and Local Area Network (LAN) connections, in particular to Wide Area Network (WAN) interfaces with at least one LAN connection and/or an external WAN interface (e.g. USB or Ethernet).

### DESCRIPTION OF RELATED ART

Wireless communications have become ubiquitous in today's society, and as wireless systems capabilities increase so does the adoption rate of wireless technologies. Today, wireless technologies are fast overtaking and replacing conventional wired technologies and infrastructure.

### BRIEF SUMMARY OF THE DISCLOSURE

In accordance with one embodiment, a system for providing an intelligent WAN switching may comprise a cellular router. The cellular router includes computer code that when executed, causes the cellular router to: receive one or more user inputs to select one or more network connection parameters corresponding to a primary network connection; receive one or more user inputs to set priority of each of the one or more network connection parameters; receive one or more user inputs to set a threshold level for each of the one or more network connection parameters; monitor the one or more network connection parameters based on the set priority of each of the one or more network connection parameters and the threshold level of each of the one or more network connection parameters; and switch a primary network connection to a secondary network connection based on the monitoring of the one or more connection parameters.

In some embodiments, the computer code further causes the cellular router to monitor the primary and secondary networking connections and reroute to the networking connection that meets the one or more network connection parameters.

In some embodiments, the one or more network parameters comprise one or more of a signal strength, signal quality, data usage status, network throughput, network latency, network jitter, serving system bandwidth/capacity, carrier roaming agreements and a connection time-period.

In some embodiments, the cellular router contains at least one of a cellular WAN interface, a local access network (LAN) connection, and an external WAN interface.

In some embodiments, the computer code, when executed, further causes the cellular router to reroute one or more times to one or more networks while monitoring the network parameters of the primary network.

In some embodiments, the computer code, when executed, further causes the cellular router to switch back to the primary network connection after a predetermined time regardless of the status of the network connection parameters.

In some embodiments, the computer code, when executed, further causes the cellular router to determine where the primary network needs adjusted network connection parameters and adjusts the network connection parameters.

In some embodiments, the computer code, when executed, further causes the cellular router to predict any adjustments needed to the network connection parameters to facilitate an optimal network connection.

In some embodiments, the system further comprises an adaptor and the computer code, when executed, further causes the cellular router to download a configuration file and automatically configure the adaptor.

In some embodiments, the computer code, when executed, further causes the cellular router to enable video surveillance.

In some embodiments, the computer code, when executed, further causes the cellular router to determine whether a different video resolution would improve the connection to the primary network and change the video resolution to the different video resolution.

In some embodiments, the network parameters have a default threshold range and a default priority level.

In accordance with another embodiment, a method for connecting a cellular router to an optimal network comprises: receiving one or more user inputs to select one or more network connection parameters corresponding to a primary network connection; receiving one or more user inputs to set priority of each of the one or more network connection parameters; receiving one or more user inputs to set a threshold level for each of the one or more network connection parameters; monitoring the one or more network connection parameters based on the set priority of each of the one or more network connection parameters and the threshold level of each of the one or more network connection parameters; and switching a primary network connection to a secondary network connection based on the monitoring of the one or more connection parameters.

In some embodiments, the method further comprises monitoring the primary and secondary network connections and rerouting to the network connection that meets the one or more network connection parameters.

In some embodiments, the one or more network parameters comprise one or more of a signal strength, signal quality, data usage status, network throughput, network latency, network jitter, and a connection time-period.

In some embodiments, the method further comprises switching the router's connection one or more times to one or more networks while monitoring the network parameters of the primary and secondary network connections.

In some embodiments, the method further comprises determining whether one or more secondary networks is available for a connection.

In some embodiments, the method further comprises switching the router's connection back to the primary network connection after a predetermined time regardless of the status of the network connection parameters.

In some embodiments, the method further comprises determining where the primary network connection needs adjusted network connection parameters and adjusts the network connection parameters.

In some embodiments, the method further comprises predicting any adjustments to the network connection parameters needed to facilitate an optimal connection.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example 5G network with which various embodiments of the present disclosure may be implemented.

FIG. 2A illustrates a first example system in which a hotspot may be utilized.

FIG. 2B illustrates a secondary example system in which a hotspot accessory device system may be utilized in accordance with some embodiments.

FIG. 3A is a block diagram of an example hotspot in accordance with some embodiments.

FIG. 3B is a block diagram of an example accessory camera in accordance with some embodiments.

FIG. 4 illustrates an example method for WAN switching in accordance with various embodiments of the present disclosure.

FIG. 5 illustrates an example computing component that may be used in implementing various features of embodiments of the disclosed technology.

These figures are not exhaustive and do not limit the disclosure or the disclosed embodiments to the precise form disclosed.

### DETAILED DESCRIPTION

Wireless communications technology, such as 5G, promises faster data speeds and lower latency. The 5G broadcast transmission protocol devised by the 3rd Generation Partnership Project (3GPP) represents the latest in wireless communication technologies promising to revolutionize wireless data communications. 5G high-band technologies utilize extremely high frequency (EHF), or millimeter wave, that enables connectivity significantly improved over the previous generation 4G networks. 5G provides greater spectral efficiency and greater spectrum pathways to achieve increased throughput for each part of the spectrum.

While millimeter wave frequencies allow for faster data speeds, these frequencies suffer from decreased range as compared to their longer wavelength, lower frequency predecessors. Millimeter wave frequencies also suffer from greater attenuation when traveling through walls, windows and other structural components. Accordingly, 5G networks typically require a higher density of transmission through routers, mobile routers, and/or “hotspots” as compared to 4G network architectures.

To improve this density of transmission, mobile routers or “hotspots” can be used to supplement a wireless connection. Hotspots can refer to devices that can be used to access a communication network (e.g., the Internet) on a variety of devices, e.g., smartphones, laptop PCs, etc. without being tethered to a typical, stationary router installed in homes, businesses, offices, etc. That is, hotspots can use cellular data, e.g., 5G cellular data or other transport layer data, to provide internet access. Typically, a hotspot is a compact, battery-powered Wi-Fi station that taps into a cellular network, such as the aforementioned 5G network, and shares (wirelessly) its data connection with other Wi-Fi-enabled devices.

Embodiments disclosed herein may include a system and/or method for providing an intelligent WAN switching for a device such as a hotspot. Embodiments of the method may include receiving one or more user inputs to select one or more network connection parameters, which determine the operating characteristics of a particular network. These network connection parameters 402 can include, but are not limited to: signal strength, signal quality, data usage, throughput, latency, jitter, serving system bandwidth/capacity, carrier roaming agreements and time related to an active network connection. One or more inputs may also be required to set a priority level for each of the network connection parameters. A priority level determines a hierarchy associated with valid use of the network. This can include, but is not limited to, priority associated with users with access to the network or priority with the type of network to be used. In some embodiments, the user can assign weights to each of the network parameters thereby assigning priorities to them. One or more inputs may also be required to set a threshold level for each of the network connection parameters. A threshold determines the desired operating range for a wireless network based on a network connection parameter. A threshold can include, but is not limited to, a maximum, minimum, average, or other boundary associated with the value for a network connection parameter. For example, if a network connection parameter reflects data usage, the threshold value may be a maximum data usage allowed on the network. When the network uses more than the maximum data allowed, that would be an event that exceeds the threshold value.

Embodiments may be implemented to further monitor a plurality of network connection parameters, as associated with a primary network connection. Here, the primary network connection is the wireless network in use at the time the network connection parameters are monitored. The network connection parameters coincide with the operating characteristics of the primary network connection. If a connection parameter associated with the primary network connection crosses an acceptable threshold range and/or a priority level, as described above, (indicating undesirable performance), the router switches from a primary network connection to a secondary network connection. This secondary network connection is obtained in an effort to meet the threshold values and priority levels as defined above.

In some embodiments, a configurable hysteresis can be set to prevent the device from ping-ponging between multiple networks.

In some embodiments, the system and method are implemented using an accessory device that configures the hotspot. In some embodiments, the accessory device relies on static configuration based on the hotspot's use. In other embodiments, the accessory device relies on dynamic configuration determined at runtime. In some embodiments, the system may further be configured to continuously switch back and forth among the plurality of networks (or among recently selected networks) to monitor the connection parameters of the corresponding networks and to check availability of the other network interfaces.

Various embodiments may be directed to a hotspot accessory device, which can comprise a camera, or an intelligent AI edge accessory. This accessory device is connectable to a hotspot via a physical, e.g., USB. The physical connection, although not necessary, may preserve Wi-Fi capacity of the hotspot when it is implemented. The USB connection can be effectuated with a USB port/connector to which the hotspot can directly connect. The accessory device may be implemented to effectuate the system and/or method described above.

Before describing example embodiments in detail, it is useful to describe an example environment with which various embodiments may be implemented. This description of the example environment is provided for illustration purposes only. Embodiments may be implemented with any of a number of different network protocols/standards and are not limited to implementation with a 5G network.

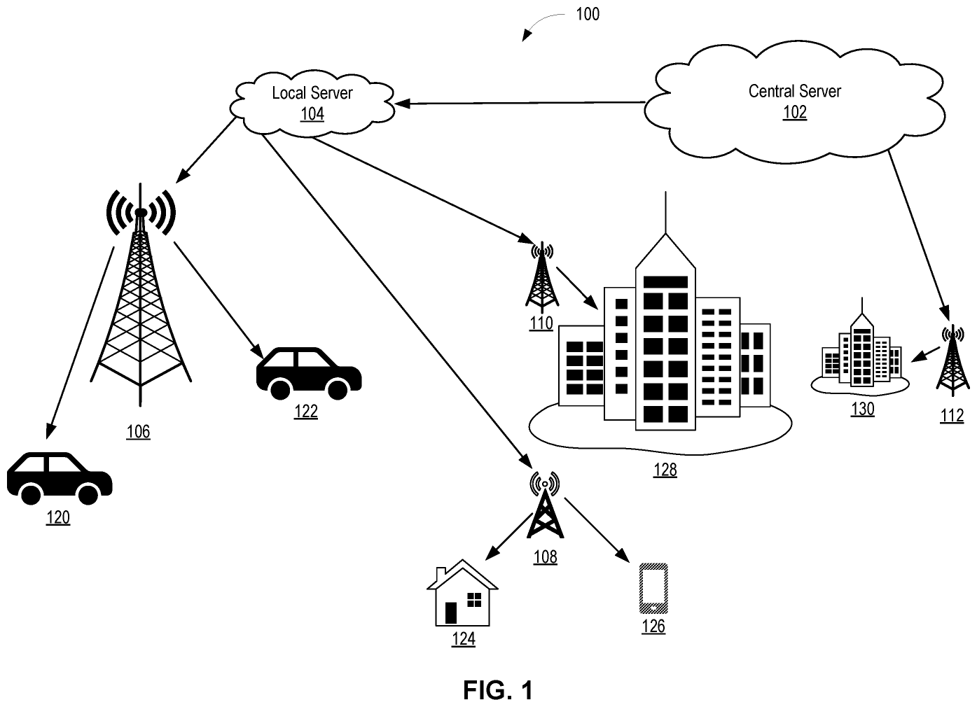

FIG. 1 illustrates a first example 5G network 100 in which or with which various embodiments of the present disclosure may be implemented. As noted above, embodiments may be implemented to apply other networks such as 4G networks. 5G is a standard promulgated by the International Telecommunication Union (ITU) and the 3rd Generation Partnership Project (3GPP), with the ITU setting the minimum requirements for 5G compliance, and the 3GPP creating the corresponding specifications. 5G is a successor to the 4G/Long Term Evolution (LTE) standard, and refers to the fifth generation of wireless broadband technology for digital cellular networks. 5G is intended to replace or augment 4G/LTE. Touted advantages of 5G include, for example, up to 10 times faster download and upload speeds, along with much-reduced latency (also referred to as “air latency,” i.e., the roundtrip time it takes for a device to communicate with the network).

The frequency spectrum of 5G includes three bands. The first band can be referred to as the low-band spectrum, i.e., the sub-1 GHz spectrum. This low-band spectrum is the first band used by U.S. wireless carriers with data speeds reaching about 100 Mbps. The secondary band can be referred to as the mid-band spectrum, i.e., the sub-6 GHz spectrum, which provides lower latency (e.g., 4-5 ms) and greater data speeds (e.g., up to 1 Gbps) relative to the low-band spectrum. However, mid-band signals are not able to penetrate structures, such as buildings, as effectively as low-band signals. The third band can be referred to as the high-band spectrum, or millimeter wave (mmWave), and operates between 25 GHz and 100 GHz. The term millimeter is associated with this high-band spectrum because wavelengths in this portion of the spectrum range from, e.g., 1-10 mm. Devices operating on this third band can deliver the highest data speed (e.g., up to 10 Gbps) and the lowest latency (e.g., 1 ms). However, its coverage area (the distance it can transfer data) is less than that of the low-band and mid-band spectrums, and building penetration decreases as the frequency increases. Use of mmWave technology is nevertheless desirable because the low-band and mid-band portions of the spectrum are already heavily congested with, e.g., TV and radio signals, as well as 4G/LTE traffic, and so long as the coverage area can be limited, the benefits of mmWave technology can still be realized.

In FIG. 1, a mobile network's radio access network (RAN) may include various infrastructure, e.g., base stations/cell towers, masts, in-home/in-building infrastructure, and the like. The RAN allows users of mobile devices, e.g., smartphones, tablet computers, laptops, vehicle-implemented communication devices (e.g., vehicles having vehicle-to-vehicle (V2V) capabilities), to the core network. The example of FIG. 1 illustrates a plurality of 5G small base stations or small cells and 5G macro base stations or macro cells, i.e., 5G macro cells 106, 110, and 112, and 5G small cell 108.

Macro cells can refer to (tall, high-powered) “macro” base stations/cell towers that are able to maintain network signal strength across long/large distances. 5G macro cells may use multiple input, multiple output (MIMO) antennas that may have various components that allow data to be sent and/or received simultaneously. In the example 5G network 100 of FIG. 1, 5G macro cell 106 may provide wireless broadband coverage/communications to vehicles 120 and 122. 5G macro cell 110 may provide broadband service to an area, such as a city or municipality 128. Likewise, 5G macro cell 112 may provide broadband coverage to an area, such as a city or municipality 130. The MIMO antennas used by 5G macro cells may comprise large numbers of antenna elements, which can be referred to as massive MIMO, whose size may be comparable to, e.g., 3G and/or 4G base station antennas.

5G small cells can refer to wireless transmitters/receivers implemented as micro base stations designed to provide coverage to areas smaller than those afforded coverage by 5G macro cells, e.g., on the order of about 100 m to 200 m for outdoor 5G small cells. Indoor 5G small cell deployments may be on the order about 10 m. 5G small cells can be mounted or integrated into/onto street lights, utility poles, buildings, etc., and like 5G macro cells, may also leverage massive MIMO antennas. In the example 5G network 100 of FIG. 1, 5G small cell 108 provides broadband coverage to a house 124 and smartphone 126.

The core network may comprise the mobile exchange and data network used to manage the connections made to/from/via the RAN. As illustrated in FIG. 1, the core network of 5G network 100 may include central server 102 and local server 104. Central server 102 is shown to effectuate broadband service to municipality 130 by way of 5G macro cell 112. Central server 102 may also operatively connect to local server 104, which in turn, provides broadband connectivity by way of 5G macro cells 106 and 110, as well as 5G small cell 108. The use of distributed servers, such as local server 104 can improve response times, thereby reducing latency. The core network may leverage network function virtualization (instantiation of network functions using virtual machines via the cloud rather than hardware) and network slicing (segmentation of 5G network 100 in accordance with a particular application, industry, or other criteria) to provide these lower response times, and provide faster connectivity.

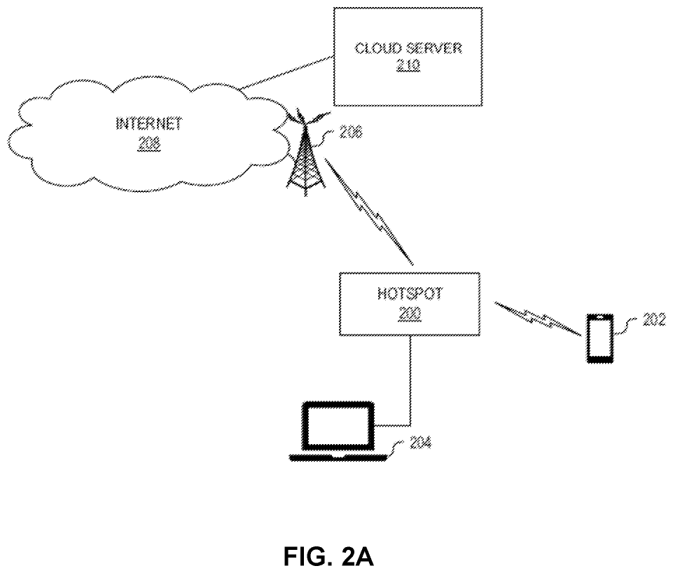

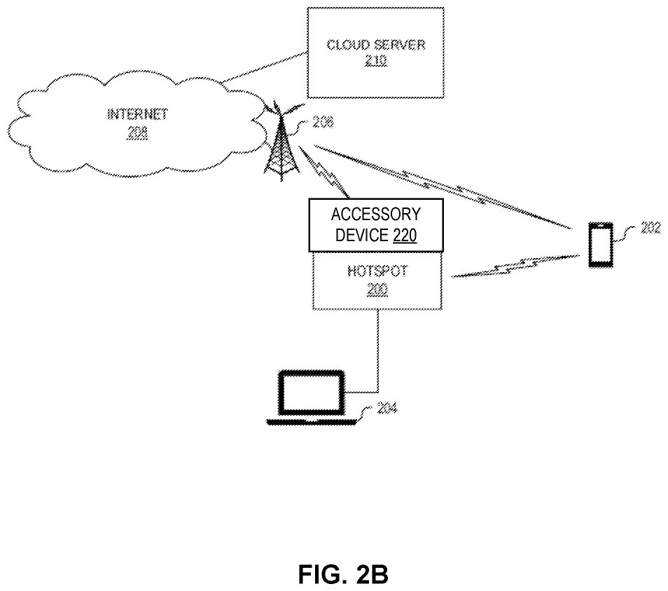

FIG. 2A illustrates an example of a typical hotspot or mobile router implementation. In FIG. 2A, hotspot 200 provides internet connectivity to user devices 202, 204 (or other Wi-Fi-capable devices not shown) through a wireless local area network (WLAN) protocol, such as IEEE 802.11 or Wi-Fi protocols. User devices 202, 204 may include, for example, a laptop, desktop, portable phone, personal digital assistant (PDA), smart phone or any other device capable of wireless communication. The number of devices which can be supported by hotspot 200 may vary and may be determined by software, firmware or the like within hotspot 200.

Hotspot 200 can be configured to communicate with a service provider through, for example, a cellular base station 206 associated with a wireless communication network, such as a wireless wide area network (WWAN) (e.g., 5G network). Through the wireless communication network, access to a communication network such as the Internet 208 may be provided. Any of a number of servers (e.g., cloud server 210) may be accessed by a user device through hotspot 200 and communication network 208.

As alluded to above, wireless communications have become ubiquitous along with the use of smartphones that typically have built-in cameras. Due to their size, thermal design, and construction, smartphones tend to throttle down data rates they are able to sustain quickly. On the other hand, hotspots, such as hotspot 200, are generally designed specifically to sustain high data rates for longer periods of time, again, typically converting cellular data signals (e.g., 4G or 5G) into Wi-Fi signals for connection to user devices.

FIG. 2B illustrates a secondary example system in which a hotspot accessory device system may be utilized in accordance with some embodiments. In some examples, the accessory device 220 can configure the hotspot. Accessory device 220 may rely on static configuration information to configure the hotspot 200 based on the hotspot's use. In other embodiments, accessory device 220 relies on dynamic configuration determined at runtime. In some embodiments, hotspot 200 (with accessory device 220) may be configured to continuously switch back and forth among the plurality of networks (or among recently selected networks) to monitor the connection parameters of the corresponding networks and to check availability of the other network interfaces.

In some embodiments, the accessory device 220 can be designed with edge processing and artificial intelligence (AI) capabilities for video processing, e.g., analyzing video to detect various elements of a real-world scene, to perform data analytics, etc. In other embodiments, the accessory device 220 can be adapted to work with other fixed wireless access (FWA) devices.

Accessory device 220 may include a base or “dock” that accepts a hotspot device 200, and an arm that holds one or more cameras, the arm being designed to be rotatable or otherwise actuatable (for security/greater field of view (FOV), i.e. of the area surrounding the one or more cameras, and storage), and to allow cameras to be moved up and down. In some embodiments, the accessory device 220 may be embodied as part of a dock that includes a minimal clip-on design that mitigates hotspot device 200 antenna(s) disruption. The base of accessory device 220 can be designed to accommodate different hotspot devices, and/or cameras, as well as other accessories, e.g., smart speakers, gaming, AR/VR accessories, etc. In this way, hotspots can be transformed into more than just a mobile router or access point, and can be part of an end-to-end solution.

It should be noted that merely adding more processing power and/or memory to a hotspot 200 can add significant expense to that hotspot. The use of an accessory device 220 allows flexibility of use and configuration of a hotspot 200. In this way, a hotspot 200 can be used as a combined hotspot and accessory device when desired, and when not, the hotspot 200 can be used on its own. Various embodiments of the disclosed technology can be used to effectuate similar or alternative actions/operations depending on various scenarios or situations in which a hotspot accessory camera system is deployed and used.

Although various embodiments may be described in terms of this example environment, the technology disclosed herein can be implemented in any of a number of different environments. As noted above, certain functionality/processing functions for the accessory device can be pushed to the edge to avoid possibly high costs associated with cellular data transmission.

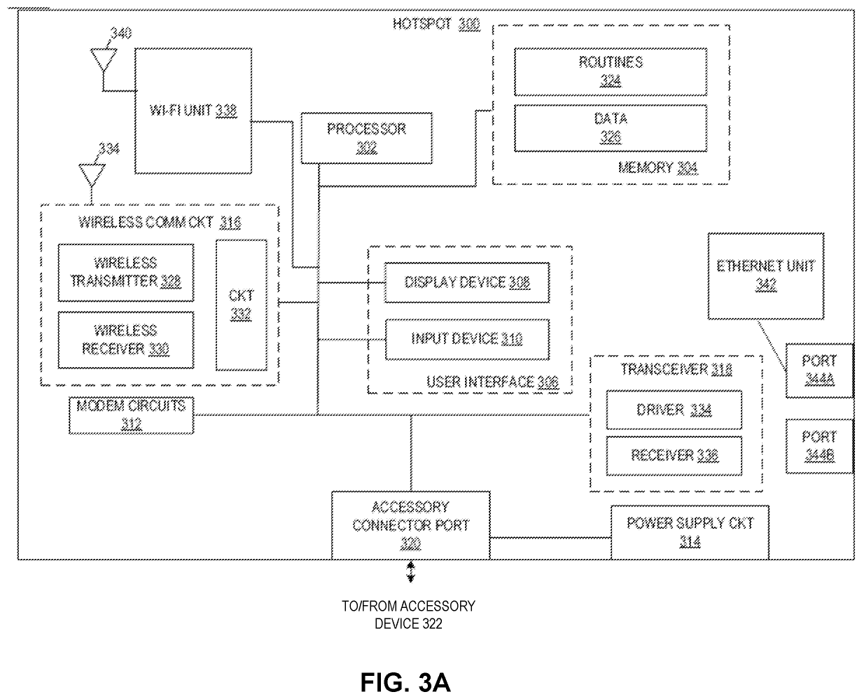

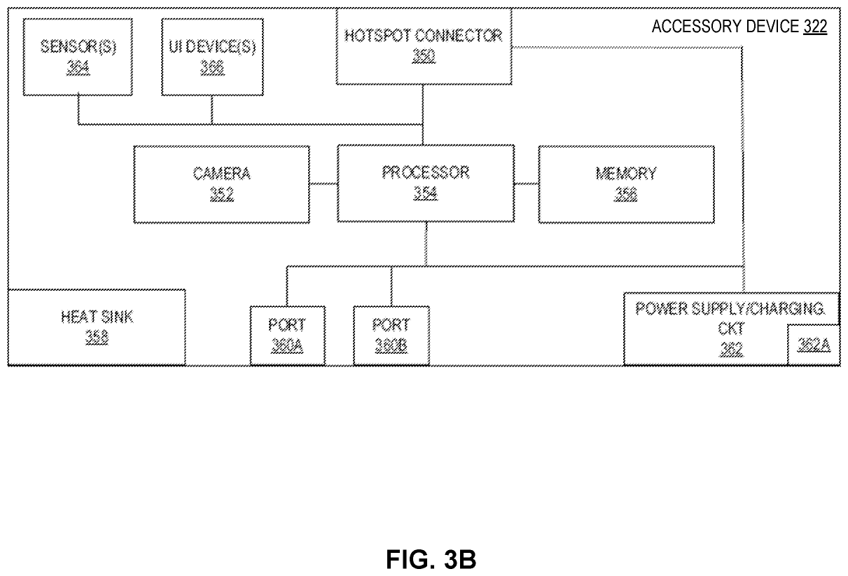

FIG. 3A is a schematic representation of an example hotspot 300, e.g., a 5G hotspot. Hotspot 300 may include a processor 302, a memory 304, user interface(s) 306 which may be in the form of a display device 308 and an input device 310, modem circuits 312, power supply circuit(s) 314, a 5G wireless communication circuit 316, an accessory connector port 320, and a Wi-Fi unit or circuitry 330. In some embodiments, the cellular router or hotspot contains at least one of a cellular WAN interface, a LAN connection, and an external WAN interface. The external WAN interface may take the form of a USB, Ethernet, or wireless interface such as a hotspot.

Processor 302 may be implemented as a dedicated or general-purpose processor or combination of processors or computing devices to carry out instructions and process data. For example, processor 302 may access memory 304 to carry out instructions, including routines 324, using data including data 326. Processor 302 may include one or more single core, dual core, quad core or other multi-core processors. Processor 302 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processing device. The aforementioned AI, data analytics, monitoring, and/or other functionalities can be realized via processor 302, or at least in part, via processor 302. Other modem circuits 312 may be provided to perform other modem functions.

Memory 304 includes memory locations for storing instructions or other routines 324 and data 326. Memory 304 may be implemented using any machine-readable or computer-readable media to store data and instructions, including volatile and nonvolatile memory. Memory 304 may be implemented, for example, as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory or other solid state memory, polymer memory, ferroelectric memory, silicon-oxide-nitride-oxide-silicon (SONOS) memory, holographic or other optical storage, or other memory structures. Although memory 304 is illustrated as a separate component in FIG. 3A, part or all of memory 304 can be implemented on the same integrated circuit as processor 302 or otherwise form part or all of embedded memory of processor 302.

Wireless communication circuit 316 may include a wireless transmitter 312, a wireless receiver 330, communication circuitry 332 and antenna 334 (to effectuate communications between hotspot 300 and a serving GnB(s). Communication circuitry 332 may be implemented as a communications processor using any suitable processor logic device to provide appropriate communications operations such as, for example, baseband processing, modulation and demodulation, and other wireless communication operations. Where certain operations such as modulation and demodulation are performed in the digital domain, analog-to-digital and digital-to-analog conversion circuitry can be included to provide the appropriate interfaces between communication circuitry 332 and wireless transmitter 328/wireless receiver 330.

Transceiver 318 may be included to provide a hardwired communications interface between hotspot 300 and an accessory device 322 (which will be described below) to provide data connectivity therebetween. The illustrated example includes a driver circuit 334 to transmit data to accessory device 322 and a receiver circuit for 336 to receive data from accessory device 322 or one or more network elements/devices operatively connected to hotspot 300. Using transceiver 318, data received from the 5G network intended for devices served by, e.g., a Wi-Fi unit such as Wi-Fi unit 338 (described below), can be transferred to Wi-Fi unit 338. Similarly, transceiver 318 can receive data from devices served by the Wi-Fi into 338, and provide that data to other components of hotspot 300 for processing and transmission to the 5G network via wireless communications circuit 316.

The user interface 306 in this example may include a display device 308 and an input device 310. Display device 308 may include, for example, one or more LEDs, display screens, touch screens, or other alphanumeric displays, or other display devices to communicate data or other information to a user. Input device 310 may include buttons, a keypad, a touchscreen display, or other input device to accept input from a user. In some embodiments, display device 308 may be include audio-based presentation circuitry to present information/content via audio/audible tones or queues, etc. Display device 308 and input device 310 may include attendant circuitry such as drivers, receivers and processing or control circuitry to enable operation of the devices with hotspot 300.

User interface 306 can provide a user interface to control operation of hotspot 300. It should be noted that user interface 306 is optional, and hotspot 300 need not have a user interface. A user of hotspot 300 may interact, e.g., control or configure hotspot 300 via a computing device operatively connected to hotspot 300 through wireless communications circuit 316. For example, user interface 306 may also be implemented using a separate device such as an application running on a smart phone, tablet, or other computing system. Accordingly, user interface 306 may include a wired or wireless communication interface to communicate with the smart phone, tablet or computing system running the application.

Power supply circuit(s) interface (I/F) 314 can be included to receive power provided from an external power source such as, for example, an AC mains circuit of the building via the USB connector directly, or via the USB connector by way of AC mains circuit indirectly when connected to accessory camera 322. Otherwise, hotspot 300 may be powered via a battery or similar power source 315. As will be described below, accessory device 322 may comprise its own power supply/charging circuit that can include a switch/distribution circuit that route power to hotspot 300 and accessory device 322 when hotspot 300 is operatively connected to accessory device 322, and accessory device is being powered, e.g., via the AC mains. Alternatively, if accessory device 322 is not connected to the AC mains or other external power source, accessory device 322 may draw power from battery 315 of hotspot 300 vis-à-vis power supply circuit 314.

Wi-Fi unit 338 may be embodied as a Wi-Fi router. Wi-Fi unit 338 allows for the transmission/reception of data to/from the Internet or other data network on behalf of user devices (e.g., laptop computers, table computers, smartphones, etc.) through connectivity provided by hotspot 300 via wireless communications circuit 316. It should be noted that Wi-Fi unit 338 is only an example, and other wireless routers, for example, may be implemented in accessory camera 322 to provide wireless connectivity/data transfer.

Another example of such networking functionality includes, e.g., Ethernet unit 342, which may be embodied as an Ethernet hub or switch. Ethernet unit 342 allows for a wired connection between a device(s) and hotspot 300. One or more of ports 344 (344A, 344B) may be Ethernet LAN/RJ45 ports, Universal Serial Bus (USB) ports, WAN ports, etc. It should be noted that there may more or less ports that those illustrated in FIG. 3A to accommodate varying needs/desired hotspot configurations.

Accessory connector port 320 may be a data connector port, allowing for the exchange of data between hotspot 300 and accessory device 322 (or other devices/accessories that can connect to hotspot 300). Accessory connector port 320 may be a USB port for operatively receiving a USB connector, such as one implemented on accessory device 322.

FIG. 3B illustrates a schematic representation of accessory device 322 that may be operatively connected to hotspot 300 to provide additional functionality to hotspot 300, e.g., provide AI edge processing functionality, data analytics functionality, etc. As illustrated in FIG. 3B, accessory device 322 may include a hotspot connector 350. Hotspot connector 350 may be a corresponding connector, e.g., USB connector configured to be received by/mate with accessory device connector port 320 of hotspot 300. That is, accessory device connector 320 may mate with hotspot connector 350 to physically and operationally connect hotspot 300 and accessory device 322. It should be understood (and as will be discussed in greater detail below), accessory device 322 may be configured to matingly hold hotspot 300. That is, accessory device 322 may act as an accessory dock in addition to providing processing functionality as alluded to above.

Accessory device 322 may include a camera unit 352, which may be any type of camera appropriately sized to be used as an accessory to a hotspot, such as hotspot 300, and which may embody a video camera, a still camera, a 360-degree rotatable camera, etc. The particular configuration of camera unit 352 can vary depending on manufacturer needs/desires, consumer needs/desires, etc. In some embodiments, accessory device 322 may be configured/controlled, or memory may be accessed directly through user device connected thereto. For example, upon disconnection from hotspot 300, a user can review data collected by accessory device 322, perform offline processing of the collected data, then connect hotspot 300 back to accessory device 322, and via hotspot 300, “revised” or processed data can be uploaded to cloud server 210.

Processor 354 may be implemented as a dedicated or general-purpose processor or combination of processors or computing devices to carry out instructions and process data. For example, processor 354 may access memory 356 to carry out instructions, including routines, using data including data (similar to processor 302/memory 304). Processor 354 may include one or more single core, dual core, quad core or other multi-core processors. Processor 354 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processing device. The aforementioned AI, data analytics, monitoring, and/or other functionalities can be realized via processor 354 instead of or in addition to that realized by processor 302 of hotspot 300.

Memory 356 includes memory locations for storing instructions or other routines and data, such as captured images/video from camera unit 352 and/or other data or information. In some embodiments, memory 356 may include instructions for executing a machine learning/AI model or neural network. Memory 356, like memory 304, may be implemented using any machine-readable or computer-readable media to store data and instructions, including volatile and nonvolatile memory. Memory 356 may be implemented, for example, as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory or other solid state memory, polymer memory, ferroelectric memory, silicon-oxide-nitride-oxide-silicon (SONOS) memory, holographic or other optical storage, or other memory structures. Although memory 356 is illustrated as a separate component in FIG. 3B, part or all of memory 356 can be implemented on the same integrated circuit as processor 354 or otherwise form part or all of embedded memory of processor 354. In some embodiments, memory 356 may act as a cache or buffer for captured images/video or other data prior to transmission and/or storage to a remotely located element or storage, e.g., cloud server 210 as illustrated in FIG. 2B.

Connectivity, location-based information/services, and the like can be effectuated vis-à-vis hotspot 300. That is, processor 354 may process images captured by camera unit 352 by appending time/date/location information relevant to the captured images. Such information may be received by processor 354 from hotspot 300. In some embodiments control signals or other commands may be sent to accessory camera 322 via hotspot connector 350.

Accessory device 322 may further include one or more sensors 364, such as a GPS sensor/receiver for obtaining the above-noted location-based information associated with, e.g., captured images/video. In some embodiments sensor 364 may comprise environmental sensors that can be triggered by certain environmental conditions.

Further still, accessory device 322 may include one or more user interface (UI) devices 366, such as a display, a touchscreen, one or more physical buttons, soft buttons, indicator/status light emitting diodes (LEDs), etc. with which a user may interact with/control/manage the operation of accessory camera 352. UI devices 366 may further or alternatively include audio devices, e.g., one or more microphones, speakers, etc. for effectuating voice-based control/interaction with accessory device 322. In some embodiments, camera unit 352 may include a voice-based assistant or agent through which/with which a user of accessory camera can interact.

In some embodiments, accessory device 322 may include a heat sink 358 for dissipating heat from accessory device 322 componentry and/or heat from hotspot 300. It should be understood that the example heat sink 358 as illustrated is not necessarily representative of size/placement in accessory device 322. That is, heat sink 358 may be larger, e.g., to cover, surround, or abut one or more heat-generating elements of accessory camera 322 e.g., camera unit 352, processor 354, sensor(s) 364, as well as a bottom surface of hotspot 300 that abuts a surface of a housing (described below) surrounding/encapsulating the components of accessory camera 322. In some embodiments, multiple heat sinks may be utilized (not shown) to dissipate heat from heat-generating elements of hotspot 300 and/or accessory device 322. As is understood by those of ordinary skill in the art, a heat sink, such as heat sink 340 increases heat flow away from a heat-generating element or device by increasing that element's surface area.

In some embodiments, heat sink 358 may comprise or may be operatively connected to a conductor (also referred to as a thermal interface material) made of heat conducting material(s), e.g., aluminum alloys, copper, and/or other material(s) known now or in the future. Such a conductor may be used to move heat from a heat-generating element away from the heat-generating element to protrusions, typically fins that make up heat sink 358. The fins may vary in terms of height, width, configuration, and/or separation between adjacent fins depending on the amount of cooling needed/desired in hotspot 300/accessory camera 322. Heat sink 358 as currently illustrated comprises a passive heat sink, although in other embodiments, heat sink 358 may be implemented as an active heat sink with, e.g., an attached fan (not shown) to assist in heat dissipation, or a hybrid heat sink.

Accessory device 322 may also comprise a power supply circuit(s) 362 to provide power conditioning or power conversion for components of accessory device 322 as well as hotspot 300 (if desired and if hotspot 300 is connected thereto) as well as any components resident therein, e.g., Wi-Fi unit 338 of hotspot 300, camera unit 352 of accessory camera 322, etc. For example, power supply circuit(s) 362 can supply power to different components of hotspot 300 and accessory device 322 at specific voltage and current levels appropriate for those components. Power supply circuit(s) 362 in this example, may receive power from an external power source such as, for example, an AC mains circuit of the building, or may include a power source, such as one or more battery units (not shown). In some embodiments, when power supply circuit(s) 362 is connected to the AC mains circuit, power is routed through power supply circuit(s) 362 which may include a distribution circuit or switch 362A that can power accessory device 322, and powers power supply circuit 314 of hotspot 300 via hotspot connector 350. If not connected to an external power source, accessory device 322 may draw power from hotspot 300 via hotspot connector 350.

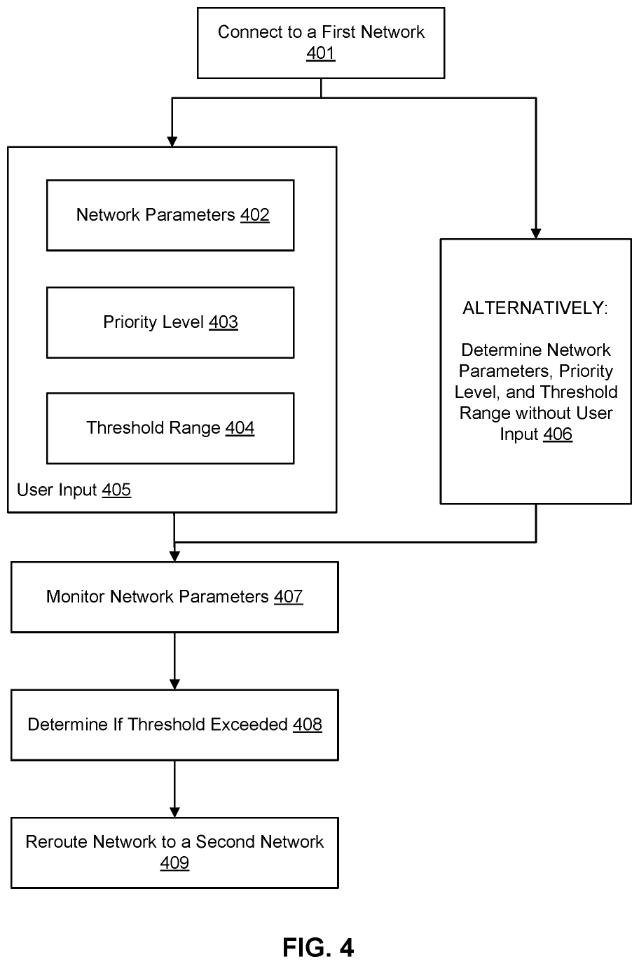

FIG. 4 illustrates an example method for switching based on network connection parameters in accordance with some embodiments. In some embodiments, this method is effectuated using the accessory device 322 and the hotspot 300 illustrated in at least FIGS. 3A and 3B.

At block 401, the process connects to a primary network. The primary network may include a 4G or 5G network, or any other wireless network.

At block 402, the process receives user input on the network connection parameters. As mentioned above, these network connection parameters can include, but are not limited to: signal strength, signal quality, data usage, throughput, latency, jitter, connection time period, serving system bandwidth/capacity, carrier roaming agreements, and time related to an active network connection. These network parameters associate with the primary network to determine the operating characteristics of the primary network. For example, if a network connection parameter is connection time period, the parameter can routinely update to note that the hotspot 300 has been connected to the primary network for a particular time. As another example, if a network connection parameter is data usage, the parameter can routinely update to list the amount of data currently in use.

At block 403, the process receives user input on the priority levels. As described above, this priority level can represent any hierarchy associated with the primary network and other available wireless network. For example, the priority level may reflect that a 5G wireless network has a higher priority than a 4G network. If a 5G and a 4G network exist, the priority level dictates that the 5G network should be favored. Alternatively, the priority level can reflect a user's priority level. For example, a user may be assigned a particular priority level that requires that the hotspot 300 be connected to a 5G network. In this case, the user's priority dictates whether the network is optimal as opposed to a direct association with the primary network connection.

At block 404, the process receives user input on the threshold range. As described above, the threshold range represents the appropriate range for a particular operating characteristic for the primary network connection. Exceeding the threshold range suggests that the network is not optimal and a different connection is recommended.

For example, a network connection parameter may be time related to an active network connection. The threshold range may include a maximum time of six hours, meaning that the network connection can only be active for six hours at a time, although this value is provided for illustrative purposes only and should not be limiting on the disclosure. If six hours has passed, the threshold range is exceeded, signaling a necessary change in network. This threshold range determined from block 404, paired with the priority level determined from block 403 and network parameters determined from block 402, formulate all user input determined at block 405 for the accessory device.

At block 406, the process may not require user input determined at block 405 for the network parameters, priority level, and threshold range. These values can be generated automatically by the system. This can be accomplished through stored default values or may be generated based on the operating characteristics of a particular network. For example, the system may generate a particular set of network connection parameters for 5G networks. The system may then modify or add additional parameters if the network does not have 5G capabilities. Additionally, the system may have some default values associated with the network connection but still require some user input determined at block 405. For example, the system may generate network parameters automatically, but may still require user input for the priority level or threshold range. This would allow the system to fill in any deficiencies if the user fails to provide all necessary information, or if the user does not require a designation for network connection parameters, priority level, and/or threshold range.

At block 407, the system monitors the network parameters associated with the network connection upon determination of the network parameters, priority level, and/or threshold range, either through user input determined at block 405 or automatically through the system determined at block 406. The system routinely reviews the operating characteristics and compares them with the network parameters. For example, the system may retrieve data on the data usage for the network connection. If that value is, for example, 100 megabytes (mb), the system may then compare that number to the threshold range value. If the threshold range is a maximum of 150mb, the system will note that the network connection does not currently exceed the threshold range. As another example, if a priority level is associated with a network such that only a particular user may access the network connection, the system may review a user's information to determine if they meet the priority level. This may be accomplished through login information, device information, or other data associated with the user.

At block 408, the system can determine if the threshold or priority levels are exceeded. As discussed above, the hotspot 300 may contain a monitoring system that evaluates the network parameters to determine whether the network characteristics exceed acceptable threshold ranges or priority levels. If the system determines that a threshold or priority was exceeded, the system can then reroute from a primary network to a secondary network at block 409 and establish a new network connection. In some embodiments, the system may comprise one or more connected devices that are simultaneously monitored by the network parameter algorithms. These algorithms will determine: 1) if the secondary networks are acceptable to switch to and will allow for zero downtime switching, and 2) prioritize the secondary networks. In some embodiments, the system can evaluate nearby networks to determine if a network is available for a connection before switching the networks. The system can also evaluate the secondary network specifically based on the network connection parameters. The system can determine if the secondary network meets threshold or priority requirements, after which the new network connection can be established. In some embodiments, the system may reroute to another network multiple times while still evaluating the network parameters of the primary network. The router may switch back to the primary network after a predetermined time regardless of the status of the network connection parameters. In some embodiments, designated primary network parameters may factor into this switch, such that the cellular router can switch back to the primary network after a predetermined time if the primary network parameters are within an acceptable range. In some embodiments, if the primary network does not meet the priority or threshold levels associated with one or more network parameters, the router/hotspot 300 is capable of making repairs to the used network, i.e. a primary or secondary network. The router may also predict needed repairs for the primary and secondary networks using machine learning as well as where those repairs are needed. The router/hotspot 300 can determine whether the network connection parameters need updates to facilitate a network connection and can update the network connection parameters, priority level, and/or threshold range accordingly. Based on the cellular network's use of the network, the/hotspot 300 can predict a needed adjustment to the network connection parameters and can act proactively.

In some embodiments, network connection parameters can be determined during a configuration phase associated with the hotspot 300 and/or accessory 322. In some embodiments, configuration is completed with a static configuration file. The system will download a configuration file from a cloud database based on a particular use and mode associated with the hotspot and accessory. The configuration files may be used to establish default settings. In some embodiments, there could be multiple configuration files based on the profile for a given installation. In some embodiments, this use or mode can be determined by the cameras or other wireless devices that connect to the hotspot 300. For example, if the hotspot 300 connects to a video surveillance camera, the system can note that that the camera provides video streaming based on the shared data between the camera and the accessory device, which in turn communicates with the hotspot 300 to download configuration files associated with video streaming.

In some embodiments, the system applies dynamic configuration. In one example, the hotspot 300 can connect to the accessory 322 and actively monitor packet statistics, data usage, and traffic pattern with the monitoring system described above. If the hotspot 300 experiences intermediate network conditions associated with the primary network (i.e. conditions that do not warrant a reroute but also do not reflect optimal connections), the accessory 322 can communicate with the hotspot 300 to alter video resolutions, bit rates, downlink and uplink bandwidth, or other modes associated with the hotspot 300. The system can then retain a connection to the primary network with enhanced performance.

In other embodiments, the system comprises other elements outside the monitoring system as described above. This can include an external adaptor that the cellular router can configure automatically. This adaptor may physically attach to at least one of the cellular router/hotspot 300 or accessory camera 322. Because of the physical connection, the router or accessory is capable of discovering the adaptor automatically. Once discovered, the adaptor can provide a proprietary interface. This proprietary interface links configuration data associated with the adaptor to the accessory 322 or hotspot 300. Once the system receives access to this configuration data, the system can complete a configuration. In some embodiments, the adaptor can link one or more interfaces to the accessory 322 or hotspot 300. Each interface can be associated with separate speed and throughput requirements. In some embodiments, the adaptors relate to specific use cases. These adaptors can apply to video surveillance, recording systems, or other broadcasts. As mentioned, the hotspot 300 may be capable of video surveillance through a camera system. If a video surveillance system is implemented, the cellular router/hotspot 300 can determine whether a different video resolution would improve the connection. If a different resolution is optimal, the router is capable of changing the video resolution appropriately by working with a hotspot to provide a higher bandwidth.

The terms “substantially” and “about” used throughout this disclosure, including the claims, are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The term “coupled” refers to direct or indirect joining, connecting, fastening, contacting or linking, and may refer to various forms of coupling such as physical, optical, electrical, fluidic, mechanical, chemical, magnetic, electromagnetic, optical, communicative or other coupling, or a combination of the foregoing. Where one form of coupling is specified, this does not imply that other forms of coupling are excluded. For example, one component physically coupled to another component may reference physical attachment of or contact between the two components (directly or indirectly), but does not exclude other forms of coupling between the components such as, for example, a communications link (e.g., an RF or optical link) also communicatively coupling the two components. Likewise, the various terms themselves are not intended to be mutually exclusive. For example, a fluidic coupling, magnetic coupling or a mechanical coupling, among others, may be a form of physical coupling.

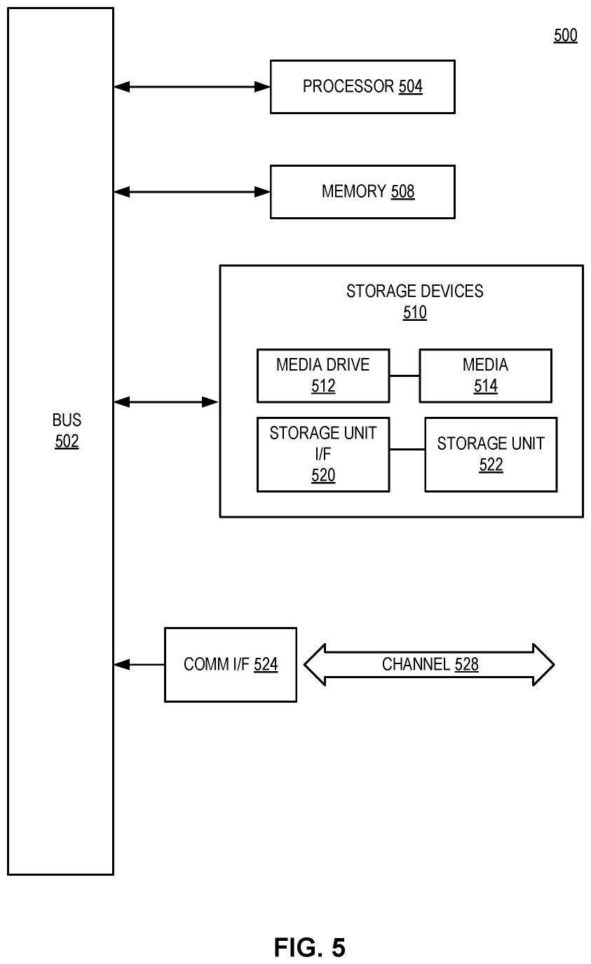

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. In other words, as would be apparent to one of ordinary skill in the art after reading this description, the various features and functionality described herein may be implemented in any given application and can be implemented in one or more separate or shared circuits in various combinations and permutations. Even though various features or elements of functionality may be individually described or claimed as separate circuits, one of ordinary skill in the art will understand that these features and functionality can be shared among one or more common circuits, and such description shall not require or imply that separate circuits are required to implement such features or functionality.

Where circuits are implemented in whole or in part using software, in one embodiment, these software elements can be implemented to operate with a computing or processing system capable of carrying out the functionality described with respect thereto. One such example computing system is shown in FIG. 5. Various embodiments are described in terms of this example-computing system 500. After reading this description, it will become apparent to a person skilled in the relevant art how to implement the technology using other computing systems or architectures.

Referring now to FIG. 5, computing system 500 may represent, for example, computing or processing capabilities found within desktop, laptop and notebook computers; hand-held computing devices (smart phones, cell phones, palmtops, tablets, etc.); mainframes, supercomputers, workstations or servers; or any other type of special-purpose or general-purpose computing devices as may be desirable or appropriate for a given application or environment. Computing system 500 might also represent computing capabilities embedded within or otherwise available to a given device. For example, a computing system might be found in other electronic devices such as, for example, digital cameras, navigation systems, cellular telephones, portable computing devices, modems, routers, WAPs, terminals and other electronic devices that might include some form of processing capability.

Computing system 500 might include, for example, one or more processors, controllers, control modules, or other processing devices, such as a processor 504. Processor 504 might be implemented using a general-purpose or special-purpose processing engine such as, for example, a microprocessor (whether single-, dual- or multi-core processor), signal processor, graphics processor (e.g., GPU) controller, or other control logic. In the illustrated example, processor 504 is connected to a bus 502, although any communication medium can be used to facilitate interaction with other components of computing system 500 or to communicate externally.

Computing system 500 might also include one or more memory modules, simply referred to herein as main memory 508. For example, in some embodiments random access memory (RAM) or other dynamic memory, might be used for storing information and instructions to be executed by processor 504. Main memory 508 might also be used for storing temporary variables or other intermediate information during execution of instructions to be executed by processor 504. Computing system 500 might likewise include a read only memory (“ROM”) or other static storage device coupled to bus 502 for storing static information and instructions for processor 504.

The computing system 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), a flash drive, or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing system 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a flash drive and associated slot (for example, a USB drive), a PCMCIA slot and card, and other fixed or removable storage units 522 and interfaces 520 that allow software and data to be transferred from the storage unit 522 to computing system 500.

Computing system 500 might also include a communications interface 524. Communications interface 524 might be used to allow software and data to be transferred between computing system 500 and external devices. Examples of communications interface 524 might include a modem or softmodem, a network interface (such as an Ethernet, network interface card, WiMedia, IEEE 802.XX, Bluetooth® or other interface), a communications port (such as for example, a USB port, IR port, RS232 port, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 508, storage unit 522, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing system 500 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various example embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described example embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of example block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A cellular router, comprising:
a processor;
a memory encoded with instructions, which when executed, cause the processor to:
receive one or more user inputs to select one or more network connection parameters corresponding to a primary network connection;
receive one or more user inputs to set priority of each of the one or more network connection parameters;
receive one or more user inputs to set a threshold level for each of the one or more network connection parameters;
monitor the one or more network connection parameters based on the set priority of each of the one or more network connection parameters and the threshold level of each of the one or more network connection parameters; and
switch a primary network connection to a secondary network connection based on the monitoring of the one or more connection parameters.

2. The cellular router of claim 1, wherein the computer code further causes the cellular router to monitor the primary and secondary networking connections and reroute to the networking connection that meets the one or more network connection parameters.

3. The cellular router of claim 1, wherein the one or more network parameters comprise one or more of a signal strength, signal quality, data usage status, network throughput, network latency, network jitter, serving system bandwidth/capacity, carrier roaming agreements and a connection time-period.

4. The cellular router of claim 1, wherein the cellular router contains at least one of a cellular WAN interface, a local access network (LAN) connection, and an external WAN interface.

5. The cellular router of claim 1, wherein the computer code, when executed, further causes the cellular router to reroute one or more times to one or more networks while monitoring the network parameters of the primary network.

6. The cellular router of claim 1, wherein the computer code, when executed, further causes the cellular router to switch back to the primary network connection after a predetermined time regardless of the status of the network connection parameters.

7. The cellular router of claim 1, wherein the computer code, when executed, further causes the cellular router to determine where the primary network needs adjusted network connection parameters and adjusts the network connection parameters.

8. The cellular router of claim 1, wherein the computer code, when executed, further causes the cellular router to predict any adjustments needed to the network connection parameters to facilitate an optimal network connection.

9. The cellular router of claim 1, further comprising an adaptor and wherein the computer code, when executed, further causes the cellular router to download a configuration file and automatically configure the adaptor.

10. The cellular router of claim 1, wherein the computer code, when executed, further causes the cellular router to enable video surveillance.

11. The cellular router of claim 10, wherein the computer code, when executed, further causes the cellular router to determine whether a different video resolution would improve the connection to the primary network and change the video resolution to the different video resolution.

12. The cellular router of claim 1, wherein the network parameters have a default threshold range and a default priority level.

13. A method for connecting a cellular router to an optimal network, the steps comprising:
receiving one or more user inputs to select one or more network connection parameters corresponding to a primary network connection;
receiving one or more user inputs to set priority of each of the one or more network connection parameters;
receiving one or more user inputs to set a threshold level for each of the one or more network connection parameters;
monitoring the one or more network connection parameters based on the set priority of each of the one or more network connection parameters and the threshold level of each of the one or more network connection parameters; and
switching a primary network connection to a secondary network connection based on the monitoring of the one or more connection parameters.

14. The method of claim 13, further comprising monitoring the primary and secondary network connections and rerouting to the network connection that meets the one or more network connection parameters.

15. The method of claim 13, wherein the one or more network parameters comprise one or more of a signal strength, signal quality, data usage status, network throughput, network latency, network jitter, and a connection time-period.

16. The method of claim 13, further comprising switching the router's connection one or more times to one or more networks while monitoring the network parameters of the primary and secondary network connections.

17. The method of claim 13, further comprising determining whether one or more secondary networks is available for a connection.

18. The method of claim 13, further comprising switching the router's connection back to the primary network connection after a predetermined time regardless of the status of the network connection parameters.

19. The method of claim 13, further comprising determining where the primary network connection needs adjusted network connection parameters and adjusts the network connection parameters.

20. The method of claim 13, further comprising predicting any adjustments to the network connection parameters needed to facilitate an optimal connection.
